(19) United States
(12) Patent Application Publication
(10) Pub. No.: US 2013/0257297 A1
(43) Pub. Date: Oct. 3, 2013

(54) LAMP COMPRISING HIGH-EFFICIENCY LIGHT DEVICES

(71) Applicant: GE HUNGARY KFT., Budapest (HU)

(72) Inventors: Gabor Schmidt, Budapest (HU); Jacint Gergely, Budapest (HU); Zsolt BAGOLY, Budapest (HU); Tamas DARANYI, Budapest (HU)

(73) Assignee: GE HUNGARY KFT., Budapest (HU)

(21) Appl. No.: 13/622,417

(22) Filed: Sep. 19, 2012

Related U.S. Application Data
(60) Provisional application No. 61/616,352, filed on Mar. 27, 2012.

(51) Int. Cl. H05B 37/02

(52) U.S. Cl. 315/182

(57) ABSTRACT

Embodiments of a lamp comprise a light source with a compact fluorescent device and a light-emitting diode device. The lamp can have a circuit with a load element that matches the light-emitting diode device with loading requirements for a dimmer switch that regulates an input power signal to the lamp. The circuit can also comprise a buffer element and sensor component, the combination of which permits selective illumination of the compact fluorescent device and the light-emitting diode device.

### BACKGROUND

1. Technical Field

The subject matter of the present disclosure relates to lamps and lighting devices and, in particular, to embodiments of a lamp that comprises a light source with a pair of high-efficiency light devices.

2. Description of Related Art

Incandescent light bulbs have been available for over 100 years. However, other light sources show promise as commercially viable alternatives to the incandescent light bulb. For example, high-efficiency light devices (e.g., light-emitting diode (LED) devices and compact fluorescent (CFL) devices) are attractive for use in lamps in part because of energy savings through high-efficiency light output.

Some lamps combine various light devices into a single, unitary lamp. These combinations offer the benefits of different types of light output. Unfortunately, LED devices are often incompatible with certain configurations and applications. For example, LED devices often cannot work with a dimmer switch. Dimming a light source saves energy when operating a light source and also allows a user to adjust the intensity of the light source to a desired level.

### BRIEF DESCRIPTION OF THE INVENTION

This disclosure describes, in one embodiment, a lamp compatible with a dimmer switch. The lamp comprises a light source with a first high efficiency light source and a second high efficiency light source. The lamp also comprises a circuit coupled to the light source. The circuit comprises a load element with a load value that permits operation of the light source with the dimmer switch. The circuit further comprises a buffer component that stores energy in response to an input power signal and a sensor component coupled to the buffer component. The sensor component is responsive to a stored energy level of the buffer component to change operation of the light source to energize the first high efficiency light source or the second high efficiency light source.

This disclosure also describes, in one embodiment, a lamp that comprises a compact fluorescent device, a light-emitting diode device, and a load element coupled to the light-emitting diode device. The load element has a load value that permits operation of the light-emitting diode device with an input power signal regulated by a dimmer switch.

This disclosure further describes, in one embodiment, a circuit for a lamp. The circuit comprises a buffer component and a sensor component coupled to the buffer component. The circuit also comprises a drive circuit coupled to the sensor component. The drive circuit comprises a load element that couples with a light source that has a light-emitting diode device. The load element has a load value that permits operation of the light-emitting diode device with an input power signal regulated by a dimmer switch. In one example, the sensor component is responsive to a stored energy level of the buffer component to selectively illuminate the light-emitting diode device.

Other features and advantages of the disclosure will become apparent by reference to the following description taken in connection with the accompanying drawings.

### BRIEF DESCRIPTION OF THE DRAWINGS

Reference is now made briefly to the accompanying drawings, in which:

FIG. 1 depicts a side view of an exemplary lamp;

FIG. 2 depicts a block diagram of another exemplary lamp;

FIG. 3 depicts a schematic wiring diagram for topology of yet another exemplary lamp;

FIG. 4 depicts an example of a load element for use in the lamps of FIGS. 1, 2, and 3; and

FIG. 5 depicts another example of a load element for use in the lamps of FIGS. 1, 2, and 3.

Where applicable like reference characters designate identical or corresponding components and units throughout the several views, which are not to scale unless otherwise indicated.

### DETAILED DESCRIPTION OF THE INVENTION

Broadly, the discussion below focuses on embodiments of a lamp with a light source that includes a pair of high-efficiency light sources. The lamp is compatible with dimmer switches and related technology, which vary the input power to the lamp to adjust characteristics of light that emanates from the lamp. In one embodiment, the lamp comprises a circuit that operates one or both of the high-efficiency light sources in response to input power. This circuit can comprise a load element that matches the light source with loading requirements of the dimmer switch.

In one implementation, the light source includes a compact fluorescent (CFL) device and a light-emitting diode (LED) device. This configuration of the light source offers a two-in-one system that emits primary lighting (e.g., through operation of the CFL device) and secondary lighting (e.g., through operation of the LED device). The secondary lighting generates light consistent with a nightlight or other applications that require lighting at relatively low light output.

Embodiments of the lamp match the light source with the loading requirements for commercial dimmer switches and related dimming technology. This feature allows the high-efficiency light sources to operate in response to changes in input (e.g. current) commensurate with actuation of the dimmer switch. For example, these embodiments can incorporate circuitry with one or more elements that can tune the loading of the light source to match the current necessary to operate with the dimmer switch. In this way, the embodiments are compatible with a wide array of applications, that utilize different types of dimmer switches, different loading currents, etc. Examples of the circuitry elements may comprise one or more discrete resistors with a fixed loading value (e.g., a fixed resistance) and/or a variable element that has a variable load value that adjusts to match the current requirements for the dimmer switch.

In other aspects, the features of the lamp described herein permit the light output (e.g., lumen output) of the light source to vary or “dim” in response to actuation of the dimmer switch. In one embodiment, the lamp can selectively operate one or both of the high-efficiency light sources in response to changes in input power that occurs via operation of the dimmer switch. This feature affords the lamp with dimming characteristics and, in one embodiment, the lamp provides extended or “deep” dimming, e.g., dimming of the light source down to 1% or less of a nominal lumen output.

Tables 1 and 2 below illustrate operating characteristics this disclosure contemplates for one embodiment of the lamp.

TABLE 1
Range A

| Input Voltage (V) | Relative Luminous Flux (mV) |
|---|---|
| 112.1 | 1101 |
| 102.9 | 1052 |
| 92.8 | 1044 |
| 82.2 | 1011 |
| 72.5 | 980 |
| 62.9 | 935 |
| 52.3 | 785 |
| 42.7 | 386 |
| 37.5 | 157 |

TABLE 2
Range B

| Input Voltage (V) | Relative Luminous Flux (mV) |
|---|---|
| 31.5 | 23 |
| 26.5 | 21 |
| 22 | 18 |
| 16.6 | 15 |

Table 1 and Table 2 show the change in light output (i.e., Relative Luminous Flux (mV)) in response to the changes to the power input to the lamp (i.e., Input Voltage (V)). The decrease in lumen output is consistent with dimming that occurs due to actuation of a dimmer switch. In one example, the light source may comprise a CFL device that operates in a first range of input voltage, identified as Range A in Table 1. The light source can also comprise an LED device that operates in a second range of input voltage, identified as Range B in Table 2.

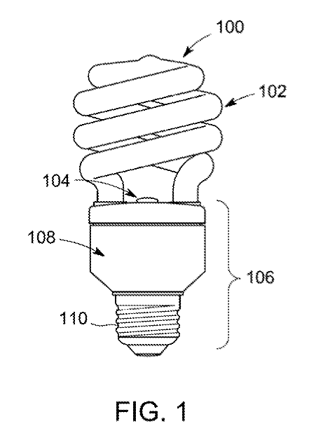

FIG. 1 depicts a side view of an exemplary lamp 100 that, as discussed above, provides various lighting (e.g., primary and secondary lighting) in response to actuation of a dimmer switch. The lamp 100 includes a light source with one or more high efficiency light sources (also, “light sources”) (e.g., a first light source 102 and a second light source 104). Examples of the light sources 102, 104 include LED devices, CFL devices, and the like. The CFL light device pictured in FIG. 1 is illustrative only. In other embodiments, it can be other types of light sources, e.g., a Decor type. These other light sources may have an outer envelope (e.g., a globe, an A-line, or a reflector shape) with various characteristics (e.g., size, shape, color, etc.).

The lighting device 100 also includes a base assembly 106 with a body 108 and a connector 110, both of which may house a variety of electrical elements and circuitry that drive and control the light sources 102, 104. Examples of the connector 110 are compatible with Edison-type lamp sockets found in U.S. residential and office premises as well as other types of sockets and connectors that conduct electricity to the components of the lamp 100. These types of connectors outfit the lamp 100 to replace existing light-generating devices, e.g., incandescent light bulbs, compact fluorescent bulbs, etc. For example, the lamp 100 can substitute for any one of the variety of A-series (e.g., A-19) incandescent bulbs often used in lighting devices.

Embodiments of the lamp 100 may also include a housing that surrounds the light sources 102, 104. The housing may comprise glass, plastic, or other types of transparent, translucent, partially-transparent, or partially-translucent material. The housing may have reflective portions or incorporate a reflective element that directs light the light sources 102, 104 generate away from the lamp 100.

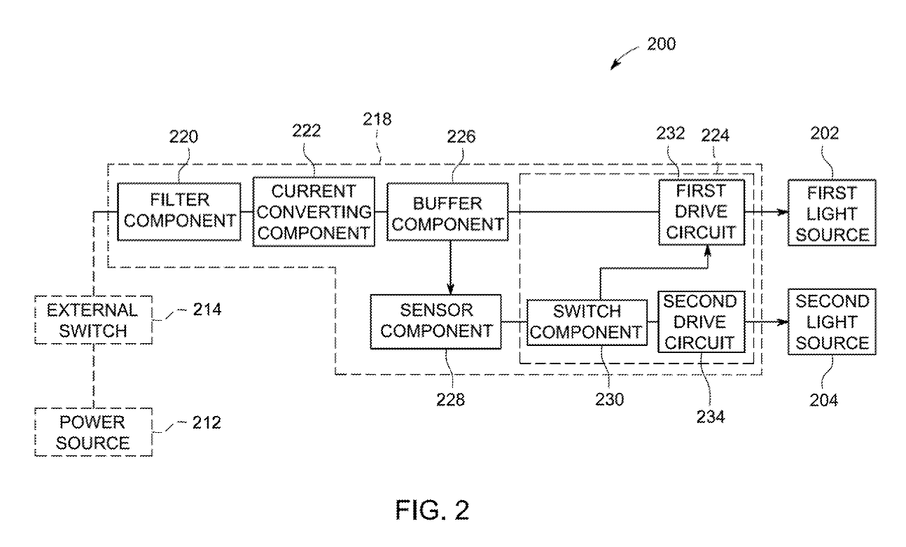

FIG. 2 illustrates a block diagram of another exemplary lamp 200 with a pair of high-efficiency light sources (e.g., a first light source 202 and a second light source 204). Examples of the high-efficiency light sources 202, 204 are characterized by an efficacy of about 50 lumens/Watt or greater. The lamp 200 couples with a power source 212 (e.g., an alternating current (AC) supply) through an external switch 214 that regulates an input power signal to the lighting device 200. Examples of the external switch 214 can have a user interface (e.g., a slider control and/or rocker control). In one example, the external switch 214 comprises a thyristor (e.g., a TRIAC) or similar component(s) and circuitry to control (and vary) the light output of the lamp 200 receives across an output range. During one operation, the external switch 214 can control the amount of power delivered to the lamp 200 by controlling the length of time the input power signal remains conductive with the external switch 214.

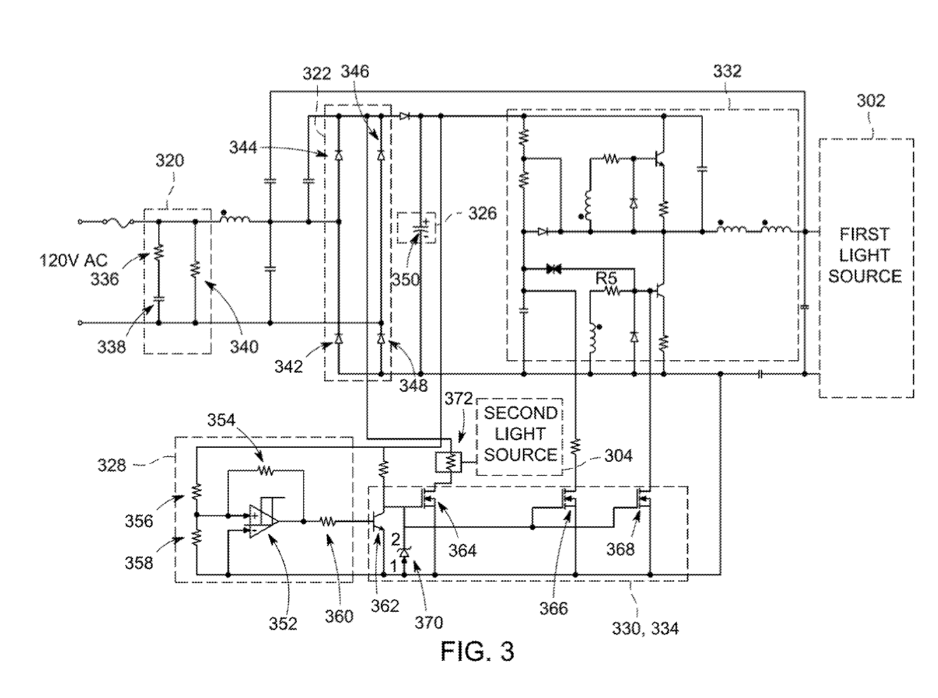

The lamp 200 includes a circuit 218 that couples with the light devices 202, 204. Examples of the circuit 218 can embody all or part of a ballast circuit, which is known to limit current flow, e.g., to fluorescent lamps. The ballast circuit may incorporate all or part of the components shown in FIG. 2 and/or other components and combinations of components described herein. As discussed more below, the components of the circuit 218 can comprise various discrete electrical components (e.g., resistors, transistor, inductors, capacitors, etc.) that reside on a substrate, e.g., a printed circuit board (PCB), semiconductor, and/or suitable substrate. These components can be found on the same and/or different substrates depending, for example, on construction and packaging constraints. This disclosure provides a detailed topology for one example of the circuit 218 in FIG. 3.

As shown in FIG. 2, in one embodiment, the circuit 218 includes a number of components (e.g., a filter component 220, a current converting component 222, and drive circuit 224). These components manipulate the input power signal to generate one or more output signals that cause the light devices 202, 204 to generate light. The circuit 218 also includes a buffer component 226 and a sensor component 228 that couples with the drive circuit 224 and the buffer component 226. The sensor component 228 monitors energy levels, e.g., at or across the buffer component 226. In one example, the sensor component 228 couples with a switch component 230, which in turn couples with one or more separate drive circuits (e.g., a first drive circuit 232 and a second drive circuit 234). The drive circuits 232, 234 drive, respectively, the first light source 202 and the second light source 204.

Construction and design of the drive circuits 232, 234 compliment the respective high-efficiency light source 202, 204 and the dimming operations associated therewith. In one embodiment, these designs can incorporate various components to operate a combination of a CFL device and a LED device. For example, the drive circuit 232 can comprise components that provide an elevated voltage level (e.g., in the range of 100 volts or more) to initiate an arc in the discharge tube of the CFL device and thereafter continue operation of the arc discharge at a lower voltage level. In one example, configurations for the drive circuit 234 can comprise components that drive an LED device, which artisans skilled in the relevant lighting arts will generally recognize as LED driver circuits and/or LED driver circuit technology. The LED driver circuit can also provide the load to the external switch during low voltage operation of the lamp 200.

In one implementation of the circuit 218, the filter component 220 modifies the input power signal to generate a filtered power signal. For example, the filter component 220 can remove and/or minimize electromagnetic interference (EMI) and noise provided by the power source 212. The current converting component 222 converts the filtered power signal to a converted power signal. Examples of the current converting component 222 can include an AC/DC rectifier (or DC/AC inverter) that convert the filtered power signal, e.g., from alternating current (AC) to direct current (DC) and/or vice versa. In one example, the converted power signal charges the buffer component 226, wherein the buffer component 226 exhibits a stored energy level in response to the converted power signal.

Examples of the sensor component 228 monitor the stored energy level and can change operation of the lamp 200. Deviation of the stored energy level from the threshold value can trigger a change in operation of the lamp 100 between the first light device 202 and the second light device 204. In one example, the sensor component 228 compares the stored energy level of the buffer component 226 to the threshold value to set the position of the switch component 230. If the stored energy level exceeds the threshold value, then the sensor component 228 may place the switch component 230 in a first position to direct the converted input power signal to the first drive circuit 232 to operate the first light device 202. On the other hand, if the energy level is less than, or equal to, the threshold value, then the sensor component 228 may place the switch component 230 to a second position to direct the converted input power signal the second drive circuit 234 to operate the second light device 204.

FIG. 3 depicts a wiring schematic that shows topology for an exemplary lamp 300. This topology includes various components (e.g., resistors, capacitors, switches, diodes, etc.) that are useful and can embody the design. This disclosure also contemplates other configurations of components that would form topologies other than that shown in the figures.

Moving from left to right in the diagram of FIG. 3, the filter component 320 includes a resistor 336 and capacitor 338, coupled together in series, and a parallel inductor 340. The current converting component 322 comprises an AC/DC rectifier, which has a set of diodes (e.g., a first diode 342, a second diode 344, a third diode 346, and a fourth diode 348). The AC/DC rectifier converts the input power signal to a DC signal. The buffering component 326 comprises a capacitor 350, with parameters (e.g., capacitance) that are selected so that the capacitor 350 will retain certain voltage (or charge) in response to the DC signal.

The sensor component 328 monitors the discharge voltage across the capacitor 350. In one example, the sensor component 328 includes a comparator 352 and a plurality of resistors (e.g., resistors 354, 356, 358, and 360). Collectively, these components generate a switching signal with known voltage profile or waveform in response to the voltage across the capacitor 350. The switching signal actuates a transistor 362, which can be a standalone component (e.g., the switch component 330) and/or part of the second drive circuit 334. The position of the transistor 362 can determine which of the drive circuits 332, 334 are energized and/or which of the light devices 302, 304 generate light.

In one embodiment, drive circuits 332, 334 can comprise components to generate appropriate output signals to the corresponding light sources 302, 304. In one example, the drive circuit 332 comprises components to operate a CFL device and, moreover, to permit changes in lumen output (e.g., dimming) in connection with the discussion herein. The second drive circuit 334 can comprise components to operate (and dim) a LED device. As shown in FIG. 3, the second drive circuit 334 can comprise one or more transistors (e.g., transistors 364, 366, 368) and diode 370 (e.g., a Zener diode).

Example of transistors 362, 364, 366, 368 include bipolar junction transistors (BJT), as well as related and derivative components (e.g., IGBTs, FETS, MOSFETS, etc.). In one embodiment, these devices are used to change the state (e.g., turn on and/or turn off) of the CFL device by stopping the resonant CFL ballast circuit. This feature permits the lamp (e.g., lamp 300) to switch operation between the first light source 302 and the second light source 304. For example, FET 362 relies on an electric field to control the conductivity of a channel, particularly the gate terminal controls electron flow from the source to the drain. During operation, the comparator 352 provides a gate voltage that can induce conductivity, thereby changing operation of the FET 362 between first and second positions. For example, when the voltage across the capacitor 350 is less than or equal to the threshold value, the gate voltage causes the FET 362 to conduct the converted power signal to the second drive circuit 334 to illuminate the second light device 302.

As also shown in FIG. 3, the drive circuit 318 can include a load element 372 that couples with the second light device 304. The load element 372 permits operation of the second light source 304 with the switch element (e.g., switch element 214 (FIG. 2) that regulates the input power signal to the lamp 300. The load element 372 can include a resistor have a fixed load value (e.g., resistance) that is selected based on the type of device for use with the second light source 304. The fixed load value generates, in one example, a load that is suited for the loading requirements of a TRIAC component, which is often found in dimmer switches.

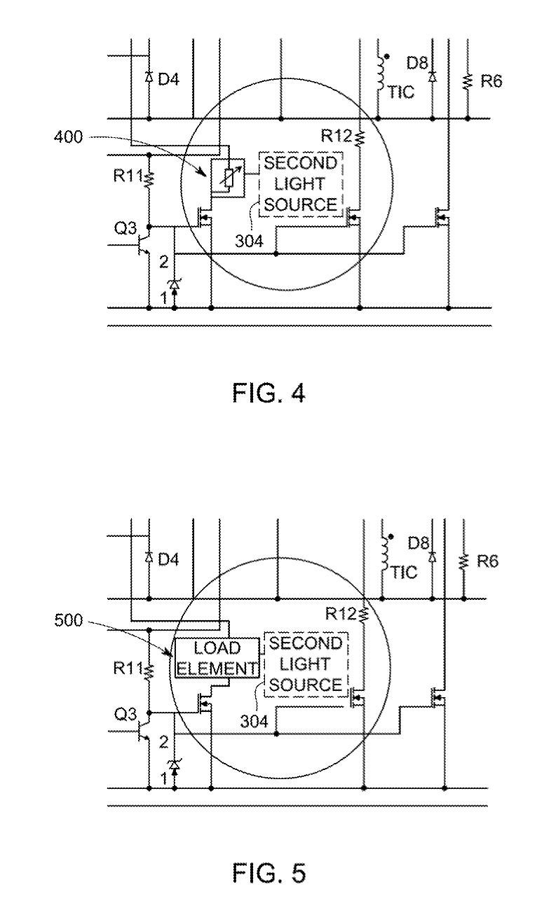

FIGS. 4 and 5 show other configurations of a load element 400 (FIG. 4) and a load element 500 (FIG. 5) for use with lamps (e.g., lamps 100, 200, 300) of the present disclosure. In FIG. 4, the load element 400 can comprise an adjustable device, e.g., an adjustable power resistor with a variable load value that can be set to match the loading required for the associated dimmer switch. The adjustable device allows the load element 400 to be tuned after manufacture and, in one example, during installation. FIG. 5 contemplates configurations in which the load element 500 comprises a specific driver circuit that couples with the second light device 304. Examples of the driver circuit can comprise various configurations of elements to form a buck converter, a boost converter, and like power converters. The output of this driver circuit can tailor to the appropriate loading required to match the second light device 304 to the loading requirements of the associated switch element.

In view of the foregoing, embodiments of the lamp discussed herein operate across a wide range of input power to generate deep dimming This disclosure contemplates variation in the construction of the lamp, e.g., constructions that include a plurality of light sources. For example, although the examples of FIGS. 1, 2, 3, 4, and 5 show embodiments with a single CFL device and a single LED device, this disclosure further considers constructions where the light source comprises a plurality of high-efficiency light sources (e.g., a plurality of CFL devices and/or a plurality of LED devices).

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

This written description uses examples to disclose embodiments of the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A lamp compatible with a dimmer switch, comprising:
a light source comprising a first high efficiency light source and a second high efficiency light source; and
a circuit coupled to the light source, the circuit comprising a load element with a load value that permits operation of the light source with the dimmer switch, a buffer component that stores energy in response to an input power signal, and a sensor component coupled to the buffer component, wherein the sensor component is responsive to a stored energy level of the buffer component to change operation of the light source to energize the first high efficiency light source or the second high efficiency light source.

2. The lamp of claim 1, wherein the light source comprises a compact fluorescent device.

3. The lamp of claim 1, wherein the light source comprises a light-emitting diode device.

4. The lamp of claim 1, wherein the light source comprises a compact fluorescent device and a light-emitting diode device.

5. The lamp of claim 1, wherein the load element has a fixed load value.

6. The lamp of claim 1, wherein the load element has a variable load value.

7. The lamp of claim 1, wherein the load element comprises a resistor coupled with the light source.

8. The lamp of claim 1, further comprising a switch component coupled with the sensor component, wherein the switch component has a first position to energize the first light source and a second position to energize the second light source.

9. The lamp of claim 1, wherein the circuit comprises a filter component to remove noise from an input power signal.

10. The lamp of claim 1, wherein the buffer component comprises a capacitor.

11. A lamp, comprising:
a compact fluorescent device;
a light-emitting diode device; and
a load element coupled to the light-emitting diode device, the load element having a load value that permits operation of the light-emitting diode device with an input power signal regulated by a dimmer switch.

12. The lamp of claim 11, further comprising a buffer component and a sensor component coupled with the buffer component, wherein the sensor component is responsive to a stored energy level of the buffer component to selectively illuminate one of the compact fluorescent device and the light-emitting diode device.

13. The lamp of claim 12, wherein the buffer component comprises a capacitor.

14. The lamp of claim 12, further comprising a switch component coupled with the sensor component and to a drive circuit that operates the compact fluorescent device and the light-emitting diode device, wherein the sensor component changes the position of the switch component to illuminate one of the compact fluorescent device and the light-emitting diode device.

15. The lamp of claim 11, wherein the load element comprises a resistor with a fixed resistance value.

16. A circuit for a lamp, said circuit comprising:
a buffer component
a sensor component coupled to the buffer component; and
a drive circuit coupled to the sensor component, the drive circuit comprising a load element that couples with a light source comprising a light-emitting diode device, the load element having a load value that permits operation of the light-emitting diode device with an input power signal regulated by a dimmer switch,
wherein the sensor component is responsive to a stored energy level of the buffer component to selectively illuminate the light-emitting diode device.

17. The circuit of claim 16, wherein the buffer component comprises a capacitor.

18. The circuit of claim 16, wherein the load element comprises a resistor.

19. The circuit of claim 16, wherein the light source further comprises a compact fluorescent device.

20. The circuit of claim 16, wherein the load element has a variable load value.
